(19) United States
(12) Patent Application Publication
(10) Pub. No.: US 2005/0259511 A1
(43) Pub. Date: Nov. 24, 2005

(54) Apparatus and method for mixing materials

(76) Inventor: Mark B. Orton, Mimbres, NM (US)

Correspondence Address: KUNZLER & ASSOCIATES, 8 EAST BROADWAY, SALT LAKE CITY, UT, 84111, US

(21) Appl. No.: 10/852,345

(22) Filed: May 24, 2004

(51) Int. Cl. B01F 7/00

(52) U.S. Cl. 366/285; 366/64; 366/207

(57) ABSTRACT

An apparatus and method are disclosed for mixing materials using a portable mixing apparatus. The portable mixing apparatus includes a base, a support stand coupled to and extending upward from the base, and an opening disposed to one side of the base and configured to receive a container. The mixing apparatus may also include a timer for terminating power to the handheld power tool upon reaching a predefined time value. The method includes providing a base, providing a support stand coupled to and extending upward from the base, and providing an opening disposed to one side of the base for receiving a container. A mixing paddle is also included with a central portion having a first end having a bend in a first direction, a second end having a second bend in an opposing direction, and a flexible portion coupled to a bottom surface formed by the central portion.

### BACKGROUND OF THE INVENTION

1. Field of the Invention

This invention relates to portable mixers for mixing concrete, mortar, paint, grout, and other substances. More particularly, the invention relates to a portable, lightweight mixing apparatus that uses common handheld power tools.

2. Description of the Related Art

Many construction and hobby projects require mixing a powdered solid with a liquid to form a mixture. Examples of material that require mixing include concrete, grout, glaze, paint, plaster, etc. Many methods for mixing exist and are currently used. For example, a painter typically mixes a bucket of paint by hand prior to use. With a paint stick, the painter is required to manually stir the paint in order to achieve a smooth consistency and even color mixture.

As with paint, other mixtures are typically mixed by hand. One solution to manual mixing has been an electric or cordless drill connected to a mixing paddle. The mixing paddle may resemble a large egg beater connected to the end of a long shaft. While the drill and mixing paddle have been sufficient for some mixing jobs, others such as concrete can require long mixing times. These long mixing times require that a user physically hold the drill and mixing container thereby taking the user away from a project or job.

In an attempt to automate mixing, many large and expensive machines have been created. One example of such a machine is a concrete mixer. The concrete mixer generally includes a rotating container having mixing blades. The concrete mixer comes in many sizes, from small containers for mixing one cubic yard or less of concrete up to large concrete trucks. A dedicated motor turns the container, and thereby the mixing blades. The container usually pivots in order to dump the resulting mixture onto a work area. Such a mixer is often expensive and difficult to transport. Additionally, the concrete mixer is impractical for most do it yourself applications.

Achieving a perfect mixture is often difficult. In order to achieve a mixture with a uniform consistency, users attempt to create a vortex within the container. The vortex allows for elements of the mixture to be properly distributed. Creating a vortex with a drill and mixing paddle is difficult due to inability of the user to maintain consistent drill speed and mixing paddle angle with respect to the container. Although automated mixing devices such as concrete mixers overcome this problem, the cost of purchasing or renting an automated mixer is prohibitive.

Low cost, portable mixing devices using a handheld power tool have been developed to automate the mixing process. These mixing devices generally include a base and a drive assembly for rotating a container. The rotating container is sufficient for mixing concrete and maintaining mixtures, however some mixtures require high speed mixing devices. Portable mixing devices with rotating containers are unable to create the vortex necessary to properly mix mixtures such as glaze.

From the foregoing discussion, it should be apparent that a need exists for an apparatus and method for mixing materials. Beneficially, such an apparatus and method would include a low cost, lightweight, portable automated mixing apparatus capable of high or low speed mixing while maintaining a constant mixing paddle angle relative to the mixing container.

### SUMMARY OF THE INVENTION

The present invention has been developed in response to the present state of the art, and in particular, in response to the problems and needs in the art that have not yet been fully solved by currently available mixing devices. Accordingly, the present invention has been developed to provide an apparatus and method for mixing materials that overcome many or all of the above-discussed shortcomings in the art.

The apparatus to mix materials is provided with a base configured to engage an approximately horizontal surface, a support stand having a first end rotatably coupled to and extending upward from the base, the support stand configured to support a handheld power tool, and an opening disposed to one side of the base and configured to receive a container. The apparatus may also comprise a first mounting plate rotatably coupled to a second end of the support stand, and a second mounting plate slidably coupled to the first mounting plate and configured to receive the handheld power tool.

In one embodiment, the apparatus comprises a plurality of retention straps configured to couple the handheld power tool to the second mounting plate. Additionally, the mixing apparatus may be configured to support the handheld power tool at a constant predefined angle relative to the container. The handheld power tool may be an electric or cordless drill, or other device with rotating capabilities.

In a further embodiment, the mixing apparatus includes a rotatable shaft having a first end configured to engage the handheld power tool and a second end rotatably coupled to a mixing paddle. The mixing paddle comprises a central portion that is elongated and rigid, and coupled to the rotatable shaft, a first end having a bend in a first direction, a second end having a second bend in an opposing direction, whereby the first and second bends cause the mixing paddle to have a substantial s-shape, and a flexible portion coupled to a bottom surface formed by the central portion.

The mixing apparatus may also include a timer configured to stop the handheld power tool upon reaching a predefined time value, and a plurality of rigid legs, each leg having a first end coupled to the base, and a second end coupled to the first mounting plate.

A method of the present invention is also presented for mixing materials. The method in the disclosed embodiments substantially includes the steps necessary to carry out the functions presented above with respect to the operation of the described apparatus. In one embodiment, the method includes providing a base configured to engage an approximately horizontal surface, providing a support stand having a first end rotatably coupled to and extending upward from the base, the support stand configured to support a handheld power tool, and providing an opening disposed to one side of the base and configured to receive a container. The method may also include attaching a mixing paddle to the handheld power tool, and coupling the handheld power tool to the support stand.

In one embodiment, the method also comprises supporting the handheld power tool at a constant predefined angle relative to a container, adjusting the position of the support stand to define a mixing angle, and slidably adjusting a mounting plate for increasing or decreasing the distance between the handheld power tool and the container. In a further embodiment, the method includes providing a timer configured to stop the handheld power tool upon reaching a predefined time value, and providing a plurality of rigid legs, each leg having a first end coupled to the base, and a second end coupled to the mounting plate

The present invention also may include a rotatable mixing paddle having a central portion that is elongated and rigid, and coupled to a rotatable shaft, a first end having a bend in a first direction, a second end having a second bend in an opposing direction, whereby the first and second bends cause the mixing paddle to have a substantial s-shape, and a flexible portion coupled to a bottom surface formed by the central portion. In one embodiment, the central portion comprises a rigid, substantially continuous, rectangular, aluminum block, and flexible portion comprises a rectangular rubber portion.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an isometric view of the top and side of a portable mixing apparatus in accordance with the present invention;

FIG. 2 is a schematic block diagram graphically illustrating one embodiment of the angle of a shaft in relation to a container in accordance with the present invention;

FIG. 3 is an exploded isometric top and side view of the portable mixing apparatus in accordance with the present invention;

FIG. 4 is an isometric view of the top and side of a portion of a first arm in accordance with the present invention;

FIG. 5 is a perspective top view of a second mounting plate in accordance with the present invention;

FIG. 6 is an isometric view of the top and side of an alternative embodiment of the portable mixing apparatus in accordance with the present invention;

FIG. 7 is an isometric view of the top and side of another alternative embodiment of the portable mixing apparatus in accordance with the present invention;

FIG. 8 is a side perspective view diagram illustrating one embodiment of a mixing paddle in accordance with the present invention;

FIG. 9 is an isometric view of the top and side of one embodiment of a container for sieving mixtures; and

FIG. 10 is a schematic flow chart diagram illustrating one embodiment of a method for mixing materials in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

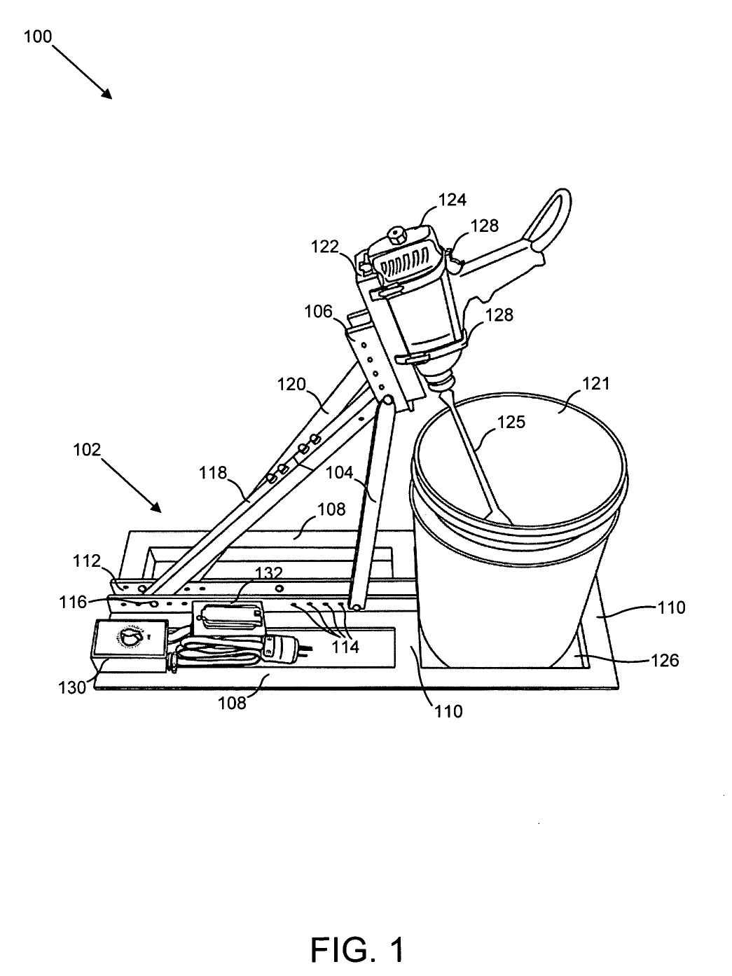

FIG. 1 is an isometric view of the top and side of a portable mixing apparatus 100 in accordance with the present invention. In one embodiment, the portable mixing apparatus 100 comprises a base 102, a support stand 104, and a first mounting plate 106. The base 102 may be formed of a plurality of parallel beam members 108 coupled by perpendicularly connected cross members 110. In a further embodiment, the beam members 108 comprise elongated metallic angle bars. Examples of metals that may be used for forming the base 102 include, but are not limited to, aluminum, iron, and steel. Each of the cross members 110 may be formed of a length of metal bar stock. Likewise, the cross members 110 may be formed of aluminum, iron, or steel. Alternatively, the beam members 108 and cross members 110 may be formed of non-metallic materials such as plastics, or ceramics.

Coupled to a top surface formed by the beam members 108 and the cross members 110 is a mounting channel 112. The mounting channel 112 may be formed of a length of aluminum U-channel, or the like. The mounting channel 112 comprises a plurality of holes for receiving a coupler 116. The coupler 116 may comprise a bolt, pin, or screw configured to couple the mounting channel 112 and the support stand 104. The plurality of holes 114 allows the support stand 104 to be positioned in many different configurations for containers of varying sizes. The support stand 104, a first arm 118, and a second arm 120 are configured to selectively maintain the first mounting plate 106 in a desired position. In a further embodiment, the mixing device 100 comprises a second mounting plate 122 slidably coupled to the first mounting plate 106 and configured to adjust the distance of a handheld power tool 124 from the container 121.

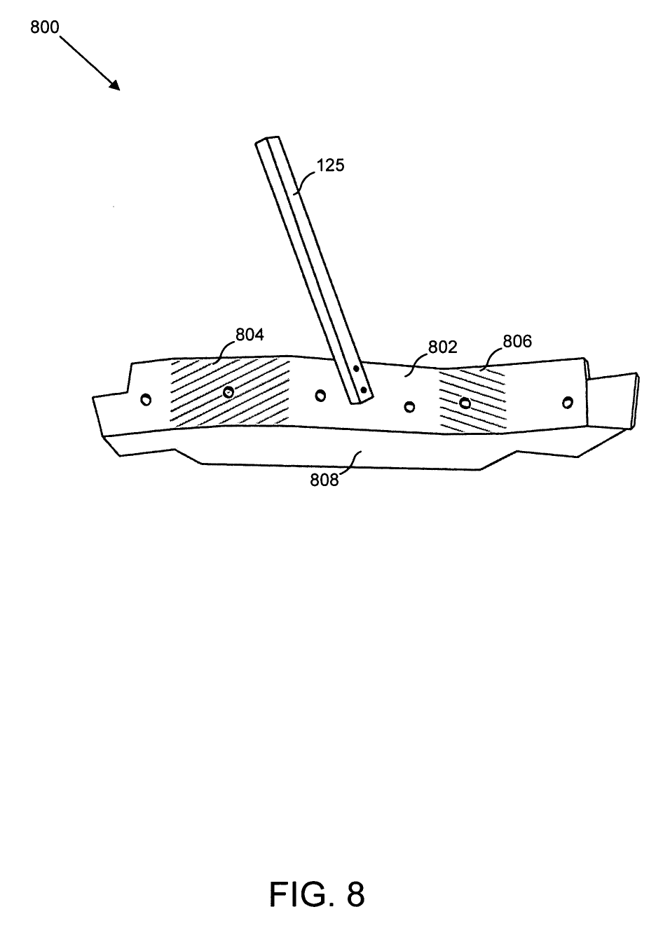

The handheld power tool 124 may comprise an electric or cordless drill configured to receive a shaft 125 of a mixing device (refer to FIGS. 7 and 8). In one embodiment, the portable mixing apparatus 100 also comprises a plurality of retention straps 128 configured to couple the handheld power tool 124 to the second mountain plate 122. The retention straps 128 may comprise a metal, plastic, or fabric strip of material configured to rigidly mount the handheld power tool 124 to the second mounting plate 122.

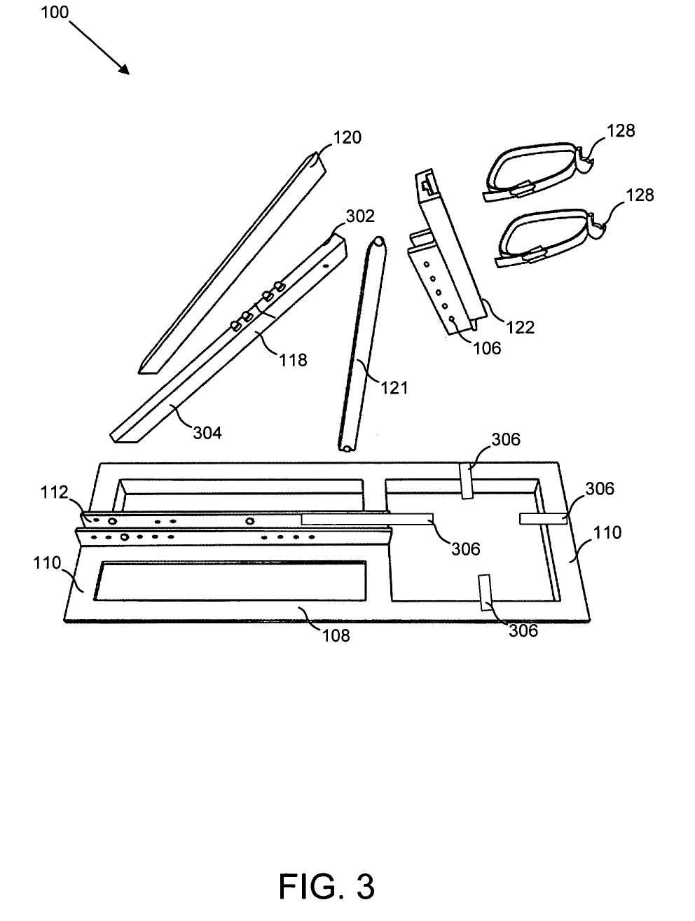

In one embodiment, the base 102 may comprise an opening 126 for receiving the container 121. In the depicted embodiment, the opening 126 is configured to receive a five gallon bucket. Alternatively, a spacer (not show) may be inserted to accommodate smaller or irregularly shaped containers 121. In a further embodiment, a stabilizing device (refer to FIG. 3) may be slidably coupled to the mounting channel 112 and configured to extend toward the container 121 in order to secure and prevent the container 121 from spinning while mixing.

In a further embodiment, the portable mixing apparatus 100 may comprise a timer 130 and a power receptacle 132. The timer 130 may be implemented as a count-down dial counter configured to terminate power to the handheld power tool 124 upon reaching a predefined time value. Alternatively, the timer 130 may comprise a LED, or electronic timer configured to count up or down and similarly cut power to the handheld power tool 124 upon reaching the predefined time value.

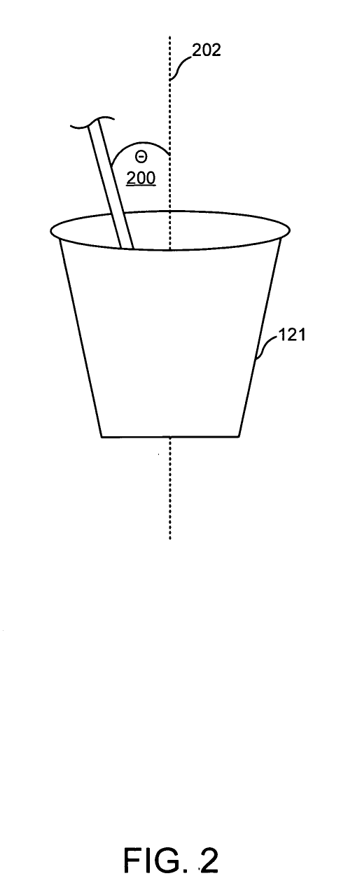

FIG. 2 is a schematic block diagram graphically illustrating one embodiment of the angle 200 of the shaft 125 in relation to the container 121. Depending upon the materials, a proper mixture is achieved by sustaining an angle 200 relative the vertical axis 202 while mixing. The high speed rotation of the shaft 125 in turn creates a vortex that evenly distributes a first material into a second material. The materials, for example, may comprise a powdered solid and water. Maintaining an ideal mixing vortex is dependant upon the mixing angle 200. Adjustments in positioning of the support stand 104, first arm 118, and second arm 120 enable the mounting plates 106, 122 to maintain the proper angle 200. The proper mixing angle 200 may be dependent upon the type of materials being mixed. For example, a mixing angle 200 of 15 degrees is desired for mixing slip for ceramic molds. However, the mounting plates 106, 122 may be positioned in any angle in the range of between about 45 and 135 degrees.

FIG. 3 is an exploded isometric top and side view of the portable mixing apparatus 100 in accordance with the present invention. In one embodiment, the support stand 104, first arm 118, and second arm 120 extend upward from the base 102 and rotate about couplers 116. The support stand 104, first arm 118, and second arm 120 may be selectively placed along the mounting channel 112 by inserting the coupler 116 through mounting channel 112 and support stand 104, first arm 118, or second arm 120. The support stand 104 is configured to support the mounting plates 106, 122 and the handheld power tool 124. In a further embodiment, the angle 200 is defined by the positioning of the first and second arms 118, 120. In order to achieve a plurality of positions, the first arm 118 may be extendable.

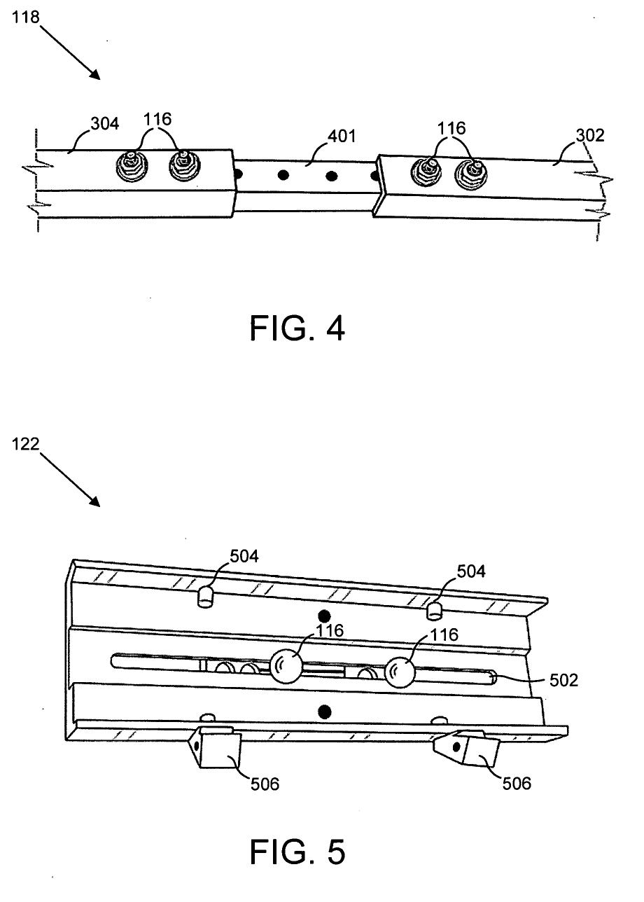

In the depicted embodiment, the first arm 118 comprises a first section 302 and a second section 304. The extendable first arm 118 will be discussed in greater detail below with reference to FIG. 4. In a further embodiment, the portable mixing apparatus 100 comprises a stabilizing device 306. The stabilizing device 306 may be slidably coupled to the mounting channel 112 and configured to extend into the container opening 126 in order to fix smaller containers and prevent the container 121 from rotating while mixing. The stabilizing device 306 may comprise a plurality of extendable bolts, or the like, for securing the container 121.

FIG. 4 is an isometric view of the top and side of a portion of the first arm 118 in accordance with the present invention. The first arm 118 may comprise the first section 302, the second section 304, and a middle section 401. In one embodiment, the first and second sections 302, 304 comprise metal bar stock having holes for receiving couplers 116. The metal bar stock may be hollow and configured to receive the middle section 401. The middle section 401 may also comprise a length of metal bar stock having holed for receiving couplers 116. In the depicted embodiment, the first and second sections 302, 304 are configured to extend outward and subsequently be secured in the extended position by the couplers 116. The couplers 116 may comprise a nut and bolt or alternatively automatic locking pins.

The extendable first arm 118 allows the mounting plates 106, 122 to be secured in a plurality of different angles 200. Alternatively, the first arm 118 may comprise a telescoping member configured to attach at one end to the mounting channel 112 and at a second end to the mounting plate 106.

FIG. 5 is a perspective top view of the second mounting plate 122 in accordance with the present invention. The second mounting plate 122 may comprise a length of U-channel aluminum having a center slot 502 configured to receive couplers 116 and allow the position of the second mounting plate 122 to be adjusted in relation to the first mounting plate 106. The length of the second mounting plate 122 may be substantially equivalent to the length of a top edge of the handheld power tool 124 (refer to FIG. 1).

In one embodiment, the second mounting plate 122 comprises attachment points 504 and attachment blocks 506. The attachment points 504 receive one end of the retention straps 128. The attachment blocks 506 are configured to receive the second end of the retention straps 128. In a further embodiment, the attachment blocks 506 may be configured to adjustably secure the retention straps 128. For example, the retention strap 128 may comprise a hose clamp having a screw for tightening or loosening the retention straps 128.

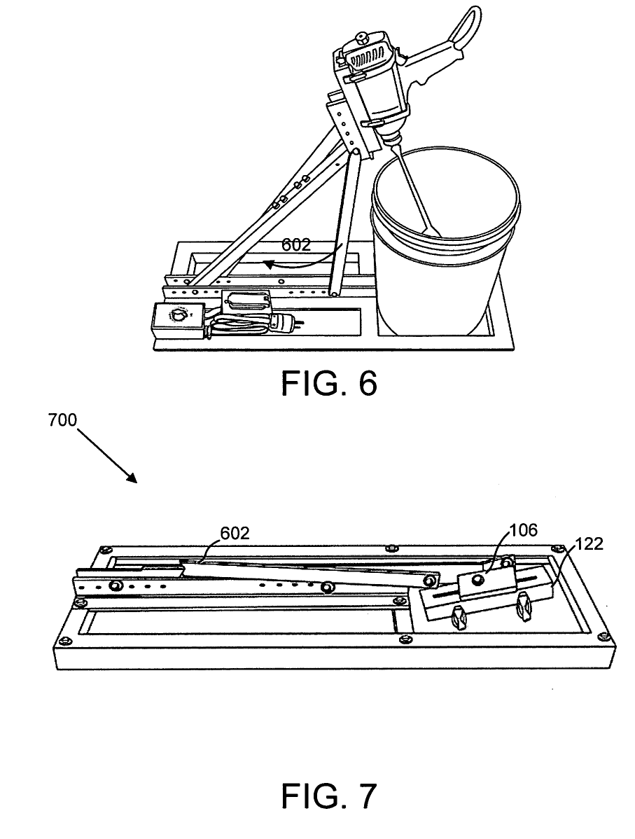

FIGS. 6 and 7 collectively illustrate an isometric view of the top and side of an alternative embodiment of the portable mixing apparatus 100 in accordance with the present invention. In the depicted embodiments, the portable mixing apparatus 100 may be collapsed into a transportation configuration 700. After removing the handheld power tool 124, a lower end 602 of the support stand 104 may be pivoted towards the first and second arms 118, 120. Once the support stand 104 has been adjoined to the first and second arms 118, 120, the mounting plates 106, 122 fold downward and may be stored within the opening 126. The resulting configuration 700 has a low profile and thereby facilitates transportation.

FIG. 8 is a side perspective view diagram illustrating one embodiment of a mixing paddle 800 in accordance with the present invention. In one embodiment, the mixing paddle 800 comprises a central portion 802 coupled to the shaft 125. The central portion 802 may comprise an elongated metallic strip having a bend 804 in a first direction and a bend 806 in a second opposing direction. In a further embodiment, the central portion 802 together with the bends 804, 806 form a substantially s-shaped mixing paddle 800.

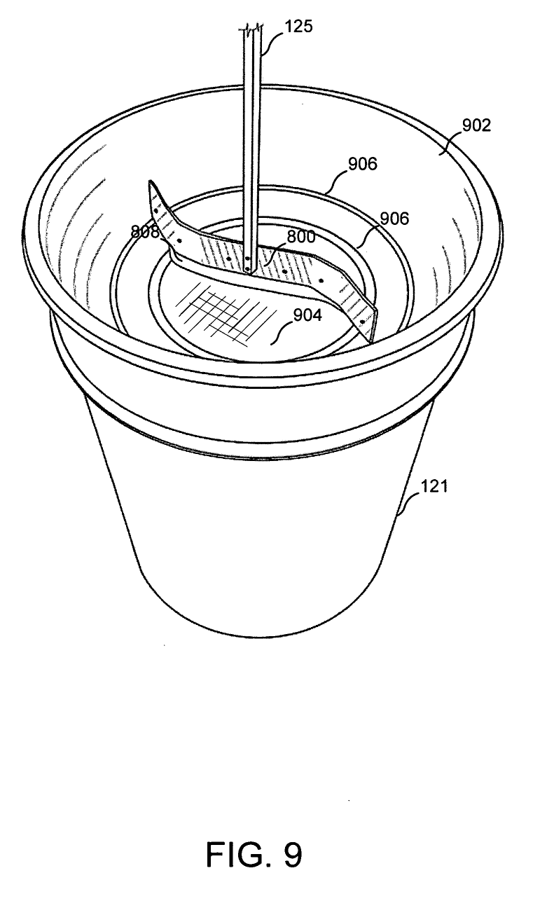

In a further embodiment, the mixing paddle 800 may comprise a flexible portion 808 coupled to a bottom surface of the mixing paddle 800. The flexible portion 808 may have a profile configured to engage a surface of the container 121 (refer to FIG. 9). The flexible portion 808 is configured to perform the function of a squeegee. The flexible portion 808 may be formed of a rubber material such as, but not limited to, polyurethane.

FIG. 9 is an isometric view of the top and side of one embodiment of a container for sieving mixtures. In one embodiment, the container 121 includes a sieving bowl 902 configured to engage the container 121. The sieving bowl 902 may comprise a sieve 904 for sieving materials. One example of a material suitable for use with sieving bowl 902 is glaze. The sieve 904 may be configured with a mesh size of 80 (number of openings per square inch), or alternatively, the mesh size may be predefined according to the mixture to be sieved.

In the depicted embodiment, the sieving bowl 902 comprises a plurality of ridges or concentric rings 906. The profile of the flexible portion 808 may be configured to form a seal on the rings 906 and thereby force the mixture through the sieve 904. Alternatively, the sieving bowl 902 may be configured without the concentric rings 906. In one embodiment, the container 121 comprises a five gallon bucket configured to capture the sieved material. Alternatively, the container 121 and the sieving bowl 902 may be of any dimension suitable for the mixture.

The following schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbology employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

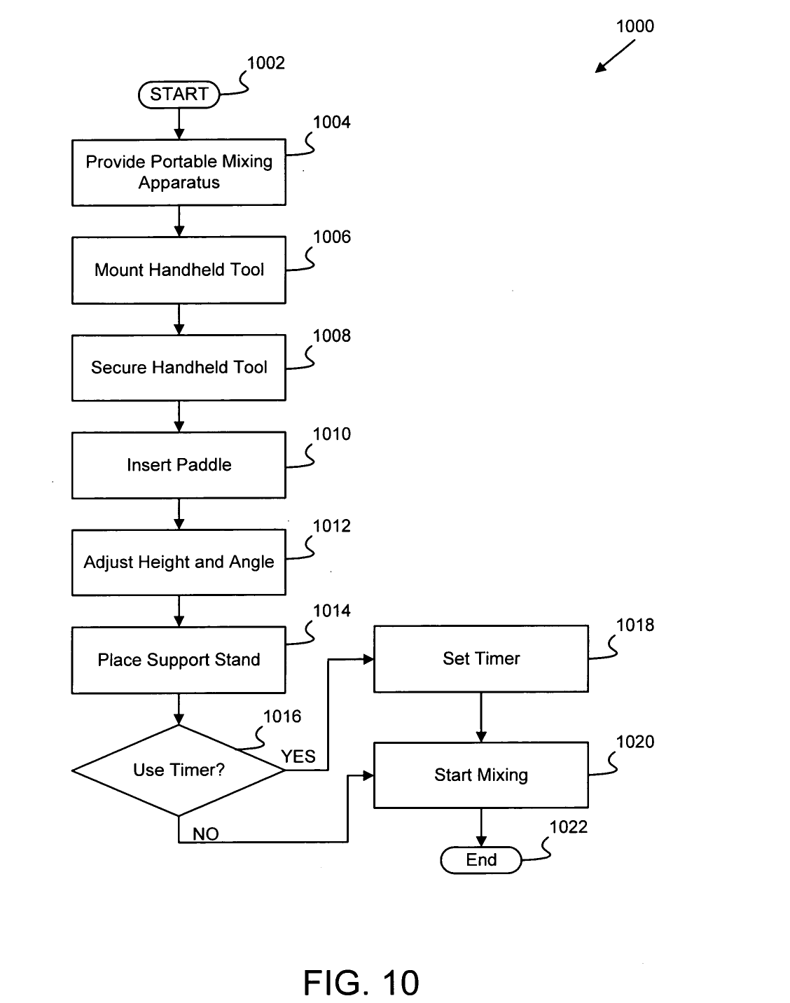

FIG. 10 is a schematic flow chart diagram graphically illustrating one embodiment of a method 1000 for mixing materials in accordance with the present invention. The method 1000 starts 1002 and the portable mixing apparatus 102 is provided 1004. A user may then mount 1006 the handheld power tool 124 to the second mounting plate 122 by first lifting the mounting plates 106, 122 and subsequently the first and second arms 118, 120 from the transportation configuration 700 and placing the handheld power tool 124 on the second mounting plate 122. The user then secures 1008 the handheld power tool 124 by tightening the retention straps 128.

In one embodiment, the user may then insert 1010 the shaft 125 of the mixing paddle 800 into the handheld power tool 124. Alternatively, any rotatable mixing apparatus suitable for use with handheld power tools 124 may be inserted 1010. Depending upon the materials and container 121 used, the user then adjusts 1012 the height and angle of the mounted handheld power tool 124 by either extending or retracting the length of the first arm 118, and/or adjusting the position of the first and second arms 118, 120 on the mounting channel 112. Once adjusted 1012, the user places 1014 the support stand 104. If the user wants to use 1016 the timer 130, the user sets 1018 the timer 130 and starts 1020 mixing. Alternatively, the user may simply start mixing 1020 at which point the method ends 1022.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An apparatus to mix building materials, the apparatus comprising:
a base configured to engage an approximately horizontal surface;
a support stand having a first end rotatably coupled to and extending upward from the base, the support stand configured to support a handheld power tool; and
an opening disposed to one side of the base and configured to receive a container.

2. The apparatus of claim 1, further comprising a first mounting plate rotatably coupled to a second end of the support stand.

3. The apparatus of claim 1, further comprising a second mounting plate slidably coupled to the first mounting plate and configured to receive the handheld power tool.

4. The apparatus of claim 1, further comprising a plurality of retention straps configured to couple the handheld power tool to the second mounting plate.

5. The apparatus of claim 1, wherein the support stand is configured to support the handheld power tool at a constant selected angle relative to the container.

6. The apparatus of claim 5, wherein the selected angle is adjustable.

7. The apparatus of claim 1, wherein the support stand is configured to support the handheld power tool at an adjustable height.

8. The apparatus of claim 1, wherein the handheld power tool comprises an electric drill configured to receive a mixing device.

9. The apparatus of claim 1, wherein the handheld power tool comprises a cordless drill configured to receive a mixing device.

10. The apparatus of claim 1, wherein the mixing device comprises a rotatable shaft having a first end configured to engage the handheld power tool and a second end rotatably coupled to a mixing paddle.

11. The apparatus of claim 10, wherein the mixing paddle comprises:
a central portion that is elongated and rigid, and coupled to the rotatable shaft;
a first end having a bend in a first direction;
a second end having a second bend in an opposing direction;
whereby the first and second bends cause the mixing paddle to have a substantial s-shape; and
a flexible portion coupled to a bottom surface formed by the central portion.

12. The apparatus of claim 1, further comprising a timer configured to stop the handheld power tool upon reaching a predefined time value.

13. The apparatus of claim 1, wherein the support stand comprises a plurality of rigid legs, each leg having a first end coupled to the base, and a second end coupled to the first mounting plate.

14. A method for mixing materials, the method comprising:
providing a base configured to engage an approximately horizontal surface;
providing a support stand having a first end rotatably coupled to and extending upward from the base, the support stand configured to support a handheld power tool;
providing an opening disposed to one side of the base and configured to receive a container;
attaching a mixing paddle to the handheld power tool; and
coupling the handheld power tool to the support stand.

15. The method of claim 14, further comprising supporting the handheld power tool at a constant predefined angle relative to a container.

16. The method of claim 14, further comprising adjusting the position of the support stand to define a mixing angle.

17. The method of claim 14, further comprising slidably adjusting a mounting plate for increasing or decreasing the distance between the handheld power tool and the container.

18. The method of claim 14, further comprising providing a timer configured to stop the handheld power tool upon reaching a predefined time value.

19. The method of claim 14, wherein providing a support stand further comprises providing a plurality of rigid legs, each leg having a first end coupled to the base, and a second end coupled to the mounting plate

20. A rotatable mixing paddle comprising:
a central portion that is elongated and rigid, and coupled to a rotatable shaft;
a first end having a bend in a first direction;
a second end having a second bend in an opposing direction;
whereby the first and second bends cause the mixing paddle to have a substantial s-shape; and
a flexible portion coupled to a bottom surface formed by the central portion.

21. The rotatable mixing paddle of claim 20, wherein the central portion comprises a rigid, substantially continuous, rectangular, aluminum block.

22. The rotatable mixing paddle of claim 20, wherein the flexible portion comprises a rectangular rubber portion.
